(19) United States
(12) Patent Application Publication
(10) Pub. No.: US 2019/0126310 A1
(43) Pub. Date: May 2, 2019

(54) SPRINKLER HEAD INDICATING SYSTEM

(71) Applicant: Donald A. Mather, Howey in the Hills, FL (US)

(72) Inventor: Donald A. Mather, Howey in the Hills, FL (US)

(21) Appl. No.: 16/169,516

(22) Filed: Oct. 24, 2018

Related U.S. Application Data
(60) Provisional application No. 62/577,311, filed on Oct. 26, 2017.
(60) Provisional application No. 62/659,433, filed on Apr. 18, 2018.

(51) Int. Cl. B05B 15/16; B05B 15/70

(52) U.S. Cl. CPC B05B 15/16; B05B 15/70

(57) ABSTRACT

The invention is directed to an in-ground sprinkler head indicating system for providing visual or other identification of the location of the sprinkler head when in a retracted position. In an example, the invention provides an indicating system for an in-ground sprinkler head having a pop-up portion, to prevent impact damage from lawn equipment and other vehicles. The indicating system comprises a top surface associated with the sprinkler head having a high visibility color or other indicator thereon. In an example the indicating systems comprises a cover member configured to be attached to the top or pop-up portion of the sprinkler head, having a high visibility color provided on the upper surface. Alternately, the indicating system may include an upper surface having a light source, and/or a proximity detector with an alert such as a sound source provided therewith. The indicating system may also be usable to identify zones of sprinkler heads in an irrigation system, with a first plurality having a first high visibility color on the upper surface, and at least one further plurality having a different high visibility color.

### CROSS REFERENCE TO RELATED APPLICATIONS

This application claims benefit of pending U.S. Provisional Patent Application No. 62/577,311, filed Oct. 26, 2017 and U.S. Provisional Patent Application No. 62/659,433, filed Apr. 18, 2018, the contents of which are incorporated herein by reference.

### FIELD OF THE INVENTION

The disclosure relates to in-ground sprinkler head indicating systems and devices to facilitate protecting and/or to identify sprinkler heads in their installed positions.

### DESCRIPTION OF RELATED ART

Yard sprinkler systems generally employ a network of underground water lines that feed individual sprinkler heads distributed around a predetermined area for watering of grass or plants for example. The sprinkler heads in many such systems include pop-up sprinkler heads, that raise above the ground surface to irrigate an area surrounding the sprinkler head location. While not in use, the sprinkler head retracts into a body to be lower profile. Though being closer to the ground surface when not in use, grass or other vegetation may obscure the sprinkler head from view, and as it is exposed at the ground surface, it can then be impacted by a person or machine, such as a lawn mower or other landscaping equipment, which can cause damage to the sprinkler head. If hit by a lawn mower for example, the sprinkler head can be damaged, cracked or broken off from the base body. Replacement of broken sprinkler heads requires digging and re-plumbing a new sprinkler head into the system, and can be costly for the owner. There is a need to avoid impact with the sprinkler head to thereby avoid damage thereto.

Additionally, when a sprinkler head needs repair, it would be desirable to be able to identify the location, as well as other information to initiate repairs. In most sprinkler systems, there are a number of sprinkler heads positioned around a property, which are typically arranged in zones. The system operates to initiate operation of the sprinkler heads in one or more zones at a time, and then switches to other zones to fully water the property. It would be desirable to be able to identify in which zone a sprinkler head is to facilitate repairs or maintenance. In addition, it would be worthwhile to allow for identifying sprinkler location to protect against damage during landscape maintenance and landscape additions.

Although attempts have been made to protect in-ground sprinkler heads, such as by the use of barriers surrounding the sprinkler head, these devices can be difficult to use and install, and may themselves be subject to damage from lawn equipment. There is thus a need for an easily used, low-cost sprinkler head indicating system that allows easy identification of the sprinkler head when in the retracted position.

### SUMMARY

In view of the foregoing need, the invention provides an in-ground sprinkler head indicator for providing visual identification of at least the location of the sprinkler head when in a retracted position. In an example, the invention provides an indicating system for an in-ground sprinkler head having a head portion such as a pop-up portion, to prevent impact damage from lawn equipment and other vehicles, comprising a cover member with an upper surface configured to be attached to the pop-up portion of the sprinkler head, and wherein the upper surface has a high visibility color provided on at least a portion of the upper surface.

In another example, the indicating system for an in-ground sprinkler head to prevent impact damage from lawn equipment and other vehicles, comprises a sprinkler head having a pop-up portion in association with a housing with an upper surface having a high visibility color provided thereon.

In another example, the indicating system for an in-ground sprinkler head to prevent impact damage from lawn equipment and other vehicles, comprises a sprinkler head having a pop-up portion in association with a housing with an upper surface having a light or audible source provided thereon.

In another example, the indicating system for an in-ground sprinkler head comprises a sprinkler head cover having an attachment portion and a cover portion, wherein the cover portion can be locked with the attachment portion, the attachment portion being attached to a top or pop-up portion of a sprinkler head.

In another example, the indicating system for in-ground sprinkler heads comprises a plurality of sprinkler head covers with an upper surface having a first high visibility color provided thereon, and at least a further plurality of sprinkler head covers with an upper surface having a further high visibility color provided thereon.

The foregoing and other examples, objects, features, and advantages of the invention will be apparent from the following more detailed descriptions of particular examples of the invention, as illustrated in the accompanying drawings.

### BRIEF DESCRIPTION OF THE DRAWINGS

FIG. 1 shows an example of a sprinkler head with the identification system according to an example mounted therewith in a retracted position.

FIG. 2 shows the sprinkler head with the identification system in an extended position.

FIG. 3 shows an example of the identification system according to the invention.

FIG. 4 shows a cross-sectional view of the identification system of FIG. 3.

FIG. 5 shows a further example of the invention.

FIG. 6 shows a further example of the invention.

FIG. 7 shows a further example of the invention.

FIG. 8 shows a further example of the invention.

FIG. 9 shows the example of FIG. 8 installed on a sprinkler head.

FIG. 10 shows a further example of the invention.

FIGS. 11 and 12 show a further example of the invention.

### DETAILED DESCRIPTION

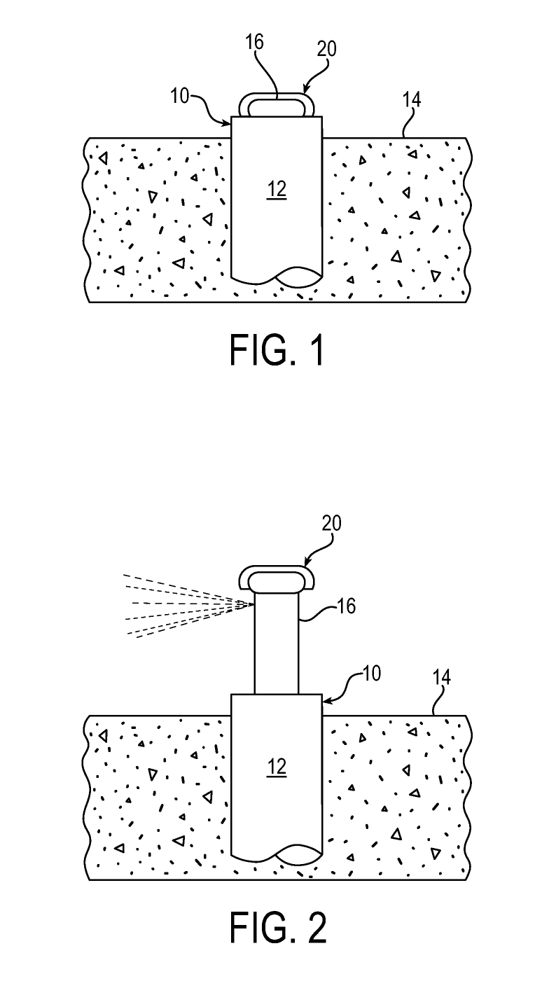

Particular examples of the present invention include an indicating system for use with a sprinkler head, to provide visual identification of the location of the sprinkler head when in the retracted, non-use position. Referring now to FIG. 1, there is shown a side view of an in-ground sprinkler head installation 10, with an indicating system 20 mounted therewith. The in-ground sprinkler head 10 includes a housing 12 which is embedded into the ground 14. The installed housing 12 may protrude slightly above the soil 14 top surface. The pop-up portion 16 of the sprinkler 10 extends above the upper extent of the protective housing 12 during operation as seen in FIG. 2, allowing unobstructed operation during sprinkling.

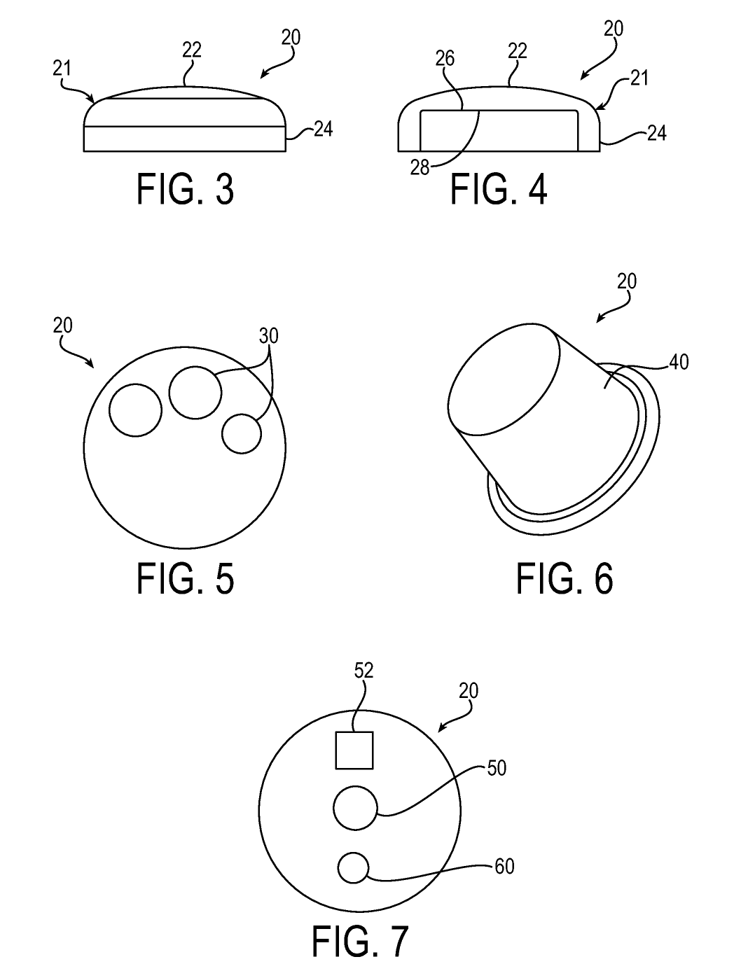

The indicating system 20 as seen in FIGS. 3 and 4 includes a member 21 mounted on the top of the sprinkler head 10, such as on the pop-up head 16, which may comprise a top wall 22 and at least one downwardly depending side surface 24. The side surface 24 engages the pop-up head 16 of the sprinkler 10, such as by frictional or other suitable engagement. The system 20 may be dimensioned to allow the engagement and retention on a particular pop-up head 16, or may be formed of a resilient or flexible material to allow it to be stretched over and engaged with the top of the pop-up head 16 or in association with various types of sprinkler heads 10. Alternately or in addition, the interior top surface 26 of the system 20 may be provided with an adhesive layer 28, that may be exposed to allow adherence to the top of pop-up head 16. The use of an adhesive layer 28 may allow mounting of the system 20 without the at least one downwardly depending side wall 24 if desired. At least the top surface 22 is colored with a high visibility color such as a fluorescent yellow, green or orange for example. The system 20 may be itself formed of a plastic type material with a high visibility color, or this may be provided by a label or in any other suitable manner to provide the high visibility color to the system 20.

Many sprinkler heads 10 are designed to provide the ability to adjust spray features such as the arc of spray, spray distance, spray character, lifting or other spray characteristics with set screws or other adjustment mechanisms. Such adjustment features are provided on the top surface of the sprinkler head 10. In this example, the top surface 22 covers at least a portion of the top of the sprinkler head 10 to prevent ingress of dirt and debris that otherwise could get inside the sprinkler head and eventually damage the rotary mechanism. In this example, the system 20 covers the top where the adjustment slots and access are located, thereby keeping debris out, which keeps the sprinkling head operating as intended. Removal of system 20 will allow access to the sprinkler head adjustments.

Referring now to FIG. 5, there is shown an alternate example of the indicating system 20. In this example, the indicating system 20 is configured to allow access to adjustment of spray adjustment features of the sprinkler 10. As noted, many sprinkler heads 10 are designed to provide the ability to adjust spray features such as the arc of spray, spray distance, spray character, lifting or other spray characteristics with set screws or other adjustment mechanisms. Such adjustment features are provided on the top surface of the sprinkler head 10, and the system 20 in this example is provided with apertures 30 that allow access to adjustment features of the sprinkler head 10. The apertures 30 are positioned to match the position of adjustment access openings of a particular sprinkler head 10 by a manufacturer. The system 20 may be configured with normally closed apertures 32 which may have a scored or slotted arrangement, or alternatively, these may simply be openings that are positioned to correspond to the adjustment access openings of a particular sprinkler head 10 to allow access to the adjustments.

In FIG. 6, another example of the system 20 is shown. In this example, the system 20 includes a raised housing section 40. In some applications, the sprinkler head 10 is installed in heavy grass or other vegetation that can obscure it from view. The indicating system 20 of this example, provides the raised housing section 40 to extend upwardly a predetermined amount to allow viewing of the high visibility color or other indicator imparted to the system 20 even in such environments.

In FIG. 7, another example of the system 20 is shown. In this example, the system 20 includes an alternate indicator such as a light source 50, which can be a LED light provided in the top section 22 of the system 20. The light 50 may be powered by a solar panel 52 or the system 20 may be provided with a battery or other suitable arrangement to power light 50. The light 50 may be colored to draw attention to the location of the sprinkler head 10 when system 20 is installed thereon. The color of the light may be selected to make the location highly visible during daylight, when most lawn equipment or the like will be in use. The light source 50 may be used in association with the high visibility color imparted to system 20 or by itself. As another alternative for use in conjunction with or separately, the system 10 may be provided with a proximity sensor 60 to provide an alarm, indicating the location of the sprinkler head 10 when approached. The alarm may be audible, visual or other suitable indicator to call attention to the location of the sprinkler head 10 when system 20 is provided therewith.

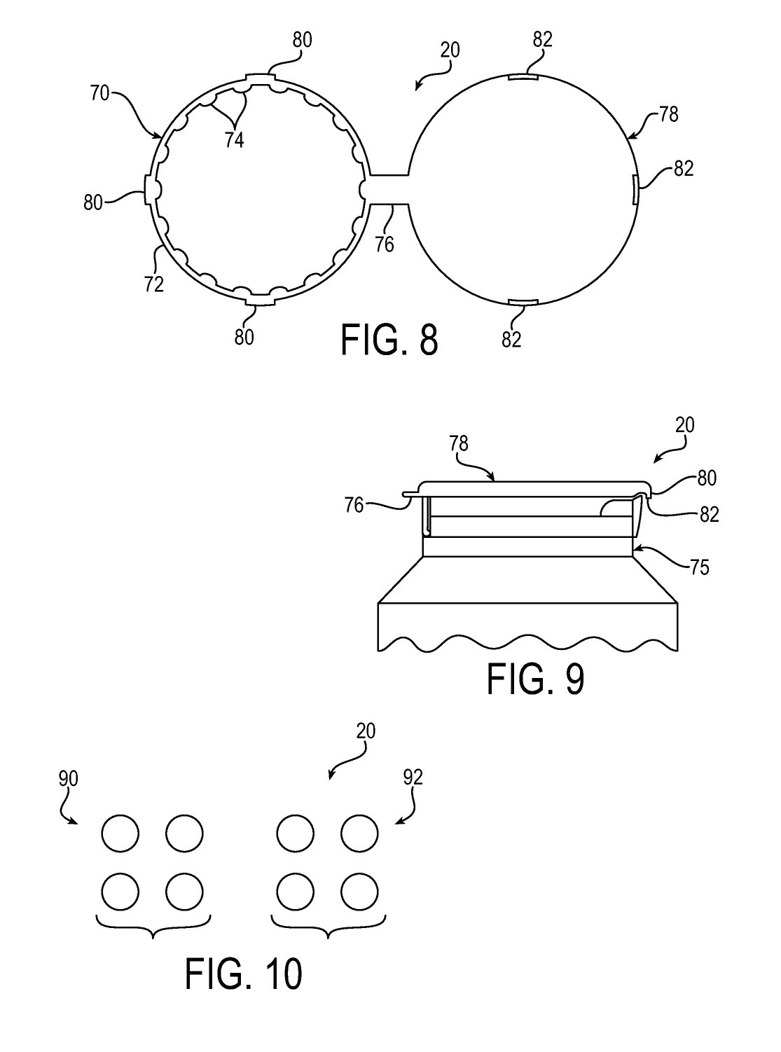

Another example is shown in FIGS. 8 and 9, wherein the system 20 includes an attachment portion 70, which may be a ring member 72 having a plurality of tabs 74 on its interior and being dimensioned to frictionally fit over and engage the top of a sprinkler head 75. The attachment portion 70 could be of other designs, such as an adhesive tab attached to the sprinkler head or other suitable configuration that would occur to the person of ordinary skill. A hinge portion 76 connects the attachment portion 70 to a cover member 78, which is foldable into position via the hinge 76 to couple to the attachment portion 70. In this example, the attachment portion 70, and ring member 72 include locking tabs 80 that engage with openings 82 formed in the cover member 78. The cover member 78 may include the high visibility color and/or other features of the system 20 according to the examples of the invention. In this example, it is also convenient to uncap the cover member 78 to allow access to the sprinkler head adjustments without removal of the system 20 from the sprinkler head. When the cover member 78 is closed though, this prevents ingress of dirt and debris that otherwise could get inside the sprinkler head and eventually damage the rotary mechanism. The cover member 78 covers the top where the adjustment slots and access are located, thereby keeping debris out, which keeps the sprinkling head operating as intended.

In another example as shown in FIG. 10, the system 20 may be used to identify particular sprinkler heads that may be arranged in zones or otherwise, to facilitate maintenance or repair on a sprinkler head. In this example, the indicating system 20 for in-ground sprinkler heads comprises a plurality of sprinkler head covers 90 with at least an upper surface having a first high visibility color or other indicator provided thereon, and at least a further plurality of sprinkler head covers 92 with an upper surface having a different high visibility color or other indicator provided thereon. Depending on the size of the irrigation system, there may be provided as many different colored indicating systems to accommodate a number of zones therein. This enables identification of the location, as well as other information relating to a group of sprinkler heads, such as to initiate repairs or maintenance. In most sprinkler systems, there are a number of sprinkler heads positioned around a property, which are typically arranged in zones. The system operates to initiate operation of the sprinkler heads in one or more zones at a time, and then switches to other zones to fully water the property. The system 20 allows the user to easily identify in which zone or combination a sprinkler heads a particular sprinkler head is in, to facilitate repairs, maintenance or for other purposes. The system 20 may also provide each of the sprinkler heads or covers with a communication device to communicate with adjacent sprinkler heads or covers, allowing for an action to be taken in the event of sprinkler head failure or the like. For example, if a sprinkler head is damaged and activation would cause unwanted water release onto a property, the communication device could signal to cease operation of one or more sprinkler heads until repair is completed. The system 20 in this example could be integrated into the sprinkler head itself, instead of being attachable to the sprinkler head, by forming the top of the pop-up head 16 itself with a plurality of sprinkler heads having at least a first high visibility color and a further plurality of sprinkler head with an upper surface having a different high visibility color provided thereon. In addition, the indicating system can be used to identify sprinkler location to protect against damage during landscape maintenance and to facilitate landscape additions.

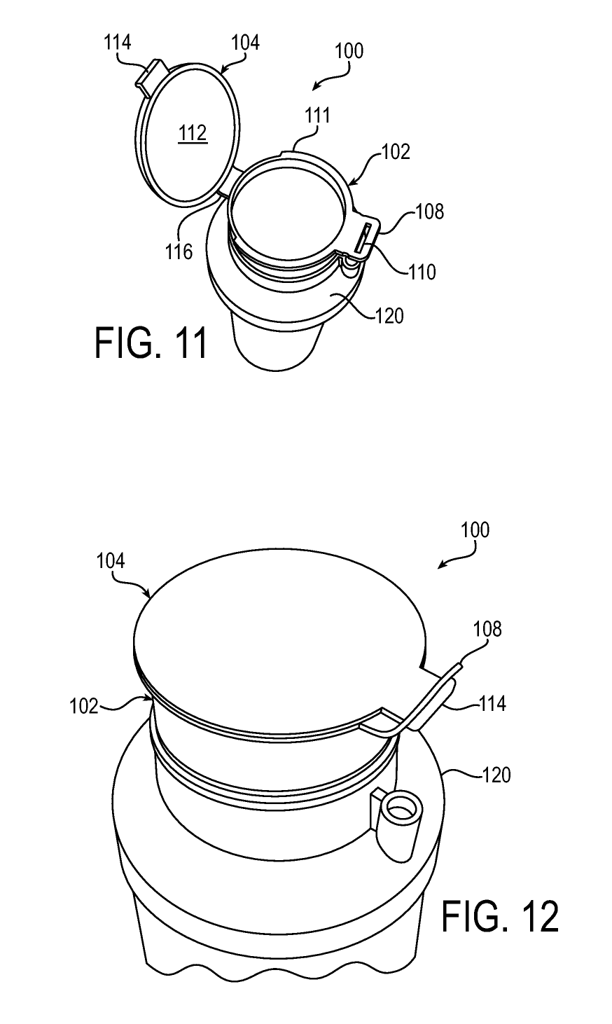

In FIGS. 11 and 12, another example of the invention comprises an indicating system 100 that also includes an attachment portion 102 and a cover member 104. A hinge portion 106 connects the attachment portion 102 to the a cover member 104, which is foldable into position via the hinge 106 to couple to the attachment portion 102. The attachment portion 102 may be formed to have a height and diameter to be frictionally engaged to the top portion of a sprinkler head 120. The attachment portion 102 also includes a retaining member or tab 108, with a slot 110 formed therein. A lip portion 111 may be formed around at least a portion of the perimeter to engage cover member 104. The cover member 104 includes a body portion 112 which covers at least a portion of the top of the sprinkler head 120 when positioned in the closed position as shown in FIG. 12. The cover member also has a locking member or tab 114, which is configured to be engaged in slot 110 of retaining member 108, and locked into place with the cover member in the close position. This connection between the locking member 114 and retaining member 108 positively retains the cover member 104 in the closed position, regardless of pressures that may be applied to the cover member 104 by mowing equipment. Mowing equipment uses one or more rotating blades that cause suction of grass into the mower housing for cutting, and this same suction may lead to opening of the cover member 104 during mowing that could result in damage to the cover member 104, but the positive connection of the cover member 104 to the attachment portion 102 prevents this. The indicating system 100 may be formed of a suitable plastic material and attachment portion 102 is configured with an interior dimension to frictionally fit over and engage the top of a sprinkler head 120. The plastic material may have some elasticity to allow stretching over different sprinkler heads 120 that may have slightly different dimensions. The attachment portion 102 could be of other designs, such as using an adhesive to attach to the sprinkler head or other suitable configuration that would occur to the person of ordinary skill. At least the cover member 104 may include the high visibility color and/or other features of the system according to the examples of the invention. In this example, the configuration again makes it convenient to uncap the cover member 104 to allow access to the sprinkler head adjustments without removal of the system 100 from the sprinkler head. When the cover member 104 is closed though, this prevents ingress of dirt and debris that otherwise could get inside the sprinkler head and eventually damage the rotary mechanism. The cover member 104 may cover the top of sprinkler head 102 where the adjustment slots and access are located, thereby keeping debris out, which keeps the sprinkling head operating as intended.

The disclosed invention provides in an example, an aftermarket indicating system for sprinkler heads in an installed sprinkler system, and one that is low cost and easily installed. It should also be understood that the system may be integrated into the sprinkler head 10 by providing the top or pop-up head 16 with the high visibility color and/or other indicator features of the system according to the examples of the invention.

With respect to the above examples, the materials, dimensions or other aspects of the system 20 may be configured to adapt to different types of sprinkler heads, and may vary accordingly, and are deemed readily apparent and obvious to one skilled in the art, and all equivalent relationships to those illustrated in the drawings and described in the specification are intended to be encompassed by the present invention.

While the above description has been presented with specific relation to particular examples of the system, it is to be understood that the claimed invention is not to be limited thereby. Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An indicating system for an in-ground sprinkler head to prevent impact damage, comprising:
a cover member with an upper surface, being configured to be attached to the top portion of the sprinkler head; and
the cover member having a high visibility color provided on at least a portion of the upper surface.

2. The indicating system of claim 1, wherein the cover member includes a retaining portion configured to be attached to the top portion of the sprinkler head and a cover portion configured to be positioned in an open or closed relationship with the retaining portion, wherein the cover portion covers at least a portion of the top of the sprinkler head when in the closed position.

3. The indicating system of claim 2, wherein the retaining portion comprises a retaining member and the cover member comprises a locking member configured to be engaged with the retaining member to positively retain the cover in the closed position when engaged.

4. The indicating system of claim 3, wherein the retaining member comprises a slot and the locking member is engaged in the slot.

5. The indicating system of claim 2, wherein at least the retaining portion is formed of an elastic material.

6. The indicating system of claim 1, wherein the cover member covers at least a portion of the upper surface of the top portion of the sprinkler head.

7. The indicating system of claim 1, wherein the upper surface of the cover member is provided with at least one aperture to allow access to adjustments of the in-ground sprinkler head.

8. The indicating system of claim 1, wherein the cover member includes a raised housing section that extends upwardly a predetermined amount.

9. The indicating system of claim 1, wherein the upper surface includes a light source.

10. The indicating system of claim 1, wherein the upper surface includes a proximity sensor.

11. The indicating system of claim 1, wherein the member includes an adhesive to attach it to the pop-up portion of the sprinkler head.

12. The indicating system of claim 1, wherein the member includes an attachment portion to engage the top of a sprinkler head, and a hinge portion connects the attachment portion to a cover portion, is the cover portion being foldable into position via the hinge to couple the cover portion to the attachment portion.

13. The indicating system of claim 1, wherein there is provided a first plurality of cover members having a first high visibility color on a top portion thereof and at least one further plurality of cover members with an upper surface having a different high visibility color provided thereon.

14. An indicating system for an in-ground sprinkler head to prevent impact damage from lawn equipment and other vehicles, comprising:
a sprinkler head having a pop-up portion in association with an upper surface having at least one indicator selected from the group consisting of a high visibility color, a light source, a sound source, a proximity detector or combinations thereof provided thereon.

15. An indicating system for an irrigation system having a plurality of in-ground sprinkler heads wherein there is provided a first plurality of sprinkler heads having a first high visibility color on a top portion thereof and at least a further plurality of sprinkler head with an upper surface having a different high visibility color provided thereon.

16. The indicating system of claim 15, further comprising a cover member with an upper surface, being configured to be attached to the top portion of each sprinkler head; and the cover member having a high visibility color provided on at least a portion of the upper surface.

17. The indicating system of claim 16, wherein the cover member includes a retaining portion configured to be attached to the top portion of the sprinkler head and a cover portion configured to be positioned in an open or closed relationship with the retaining portion, wherein the cover portion covers at least a portion of the top of the sprinkler head when in the closed position.

18. The indicating system of claim 17, wherein the retaining portion comprises a retaining member and the cover member comprises a locking member configured to be engaged with the retaining member to positively retain the cover in the closed position when engaged.

19. The indicating system of claim 18, wherein the retaining member comprises a slot and the locking member is engaged in the slot.

20. The indicating system of claim 17, wherein at least the retaining portion is formed of an elastic material.
